(19) United States
(12) Patent Application Publication
(10) Pub. No.: US 2009/0272446 A1
(43) Pub. Date: Nov. 5, 2009

(54) APPARATUS FOR TREATING A LIQUID

(76) Inventor: Klaus Kolding, Hobro (DK)

Correspondence Address: Muncy, Geissler, Olds & Lowe, PLLC, P.O. BOX 1364, FAIRFAX, VA, 22038-1364, US

(21) Appl. No.: 12/295,262

(22) PCT Filed: Mar. 21, 2007
(86) PCT No.: PCT/DK07/00139

§ 371 Date: Oct. 20, 2008

(30) Foreign Application Priority Data
Mar. 28, 2006 (DK) PA200600444

(51) Int. Cl. F15C 1/18; B67D 5/06

(52) U.S. Cl. 137/808; 137/809; 99/275

(57) ABSTRACT

An apparatus for treating a liquid; such as water or a beverage, in order to improve the quality of the liquid, and in order to ensure that the minerals and nutrients which are naturally present in the liquid are assimilated in a living organism consuming the liquid to the maximum extent. At least two pipe segments are twisted about a common axis in such a manner that each of the pipe segments at least substantially abuts said common axis. Each pipe segment has an inlet opening and an outlet opening, and the pipe segments forms parallel flow paths between a common inlet and a common outlet. The liquid performs spiraling movements when flowing through the pipe segments, and thereby the minerals in the liquid are forced to be in a more absorbable form.

### BACKGROUND OF THE INVENTION

1. Field of the Invention

The present invention relates to an apparatus for treating a liquid, such as water, a beverage, e.g. wine, etc.

2. Brief Discussion of the Related Art

In drinking water for human beings and animals it is desirable to ensure that the minerals and nutrients which are naturally present in the water are assimilated in the organism to the greatest extent possible. Thereby the human being or animals drinking the water will benefit from the minerals and nutrients to the maximum extent.

WO 02/085792 discloses an apparatus and a method for treating water or other liquid. The apparatus comprises a tubular element and a guide plate. The tubular element has an outer circumferential wall defining a through going passage therein and defining an inlet end and an outlet end. The guide plate is of an elongated configuration defining a longitudinal axis and is sidewise twisted one turn relative to the longitudinal axis. The guide plate is receivable within the passage for separating the passage into two parts for guiding water or other fluid material along the two parts of the passage from the inlet to the outlet end in one sidewise turn. Turning the liquid flow one sidewise turn provides a treatment of the liquid product which improves the quality of the liquid, in terms of less algae growth, etc.

### SUMMARY OF THE INVENTION

It is an object of the invention to provide an apparatus for treating a liquid which improves the quality of the liquid even further than prior art apparatuses.

It is a further object of the invention to provide an apparatus for treating a liquid which improves the availability of minerals and nutrients present in the liquid.

According to the invention the above and other objects are fulfilled by providing an apparatus for treating a liquid, the apparatus comprising at least two pipe segments being twisted about a common axis in such a manner that each of the pipe segments at least substantially abuts said common axis, each pipe segment having an inlet opening for receiving a flow of liquid and an outlet opening for delivering a flow of liquid, wherein the inlet openings are connectable to a common inlet providing a flow of fluid to each of the pipe segments, and wherein the outlet openings are connectable to a common outlet for leading a flow of liquid away from each of the pipe segments, the pipe segments thereby forming parallel flow paths between the common inlet and the common outlet.

The apparatus is for treating a liquid. This should be interpreted to include mechanical treatment of the liquid, e.g. in order to improve the quality of the liquid, e.g. in terms of taste, reduced algae growth, availability of naturally present nutrients or minerals, etc.

The inlet openings of the pipe segments are connectable to a common inlet opening, and the outlet openings of the pipe segments are connectable to a common outlet opening. Thereby a flow of liquid may be applied to the common inlet opening, where it is divided into the inlet openings of the pipe segments and flows parallelly along each of the pipe segments. At the outlet openings the parallel flows are again united into a single flow of liquid which leaves the apparatus via the common outlet opening.

The pipe segments preferably have an elongated shape defining a longitudinal direction, and they are hollow in order to allow a flow of liquid to pass through them. The pipe segments are twisted about a common axis in such a manner that each of the pipe segments at least substantially abuts said common axis, i.e. they are ‘entangled’, and each of the pipe segments evolve around the common axis in such a manner that a flow of liquid can pass through each of the pipe segments in a spiralling movement substantially along the direction defined by the common axis. Thereby the common axis defines a longitudinal direction of the apparatus. The pipe segments may be twisted half a turn, a full turn, two or more turns, or they may be twisted at any desired angle around the common axis. The pipe segments may be twisted either in a right direction or in a left direction, i.e. they may define a clockwise or an anti-clockwise spiralling path for the liquid.

The pipe segments are twisted about the common axis in such a manner that each of the pipe segments at least substantially abuts the common axis. Thus, the pipe segments are twisted closely together, and the spiralling paths followed by the flows of liquid through the pipe segments are therefore arranged as close as possible to the common axis. This helps in ensuring that the liquid obtains a sufficient spin when passing through the pipe segments.

It is an advantage that the liquid is passed through two or more separate pipe segments rather than through a single pipe segment which has been divided by a wall or a guide plate, because the flow of the liquid through the apparatus is more controlled, and thereby a desired spin of the liquid is obtained more easily. Furthermore, it is easier to clean individual pipe segments than a pipe segment with a guide plate positioned therein, and the hygiene level is therefore increased. This is particularly advantageous if the apparatus is used for treating a liquid which is to be consumed by a living being, e.g. a beverage or a supply of drinking water for humans or farm animals.

When the liquid performs the spiralling movement a micro turbulent flow is created, inter alia due to the centrifugal force. Thereby minerals which are present in the liquid are ‘crushed’, and these ‘crushed’ minerals are more easily absorbed by an organism than minerals which have not been ‘crushed’ in this manner. Furthermore, by letting the liquid perform a spiralling movement as described above, heavier elements present in the liquid are inclined to move towards the middle of the flow path. Thereby, instead of depositing, these heavier elements will be absorbable for an organism consuming the liquid. Accordingly, the minerals are more readily available, and they may therefore be utilised more efficiently. This is very advantageous because the nutritional value of a specific amount of liquid is thereby considerably increased. If the apparatus is, e.g., used on a supply of drinking water for farm animals, such as poultry, e.g. chicken, sheep, pork or the like, the animals will receive more minerals and more nutrients, and the growth of the animals may thereby be improved. Thus, an improved growth in pork and poultry, and improved quality of egg shells has been proved.

In case a flow of tap water is caused to pass through the apparatus, it turns out that calcium solved in the water is transformed from calcite, which is inclined to deposit on inner walls of piping, into aragonite, a microcrystalline silt which is much less inclined to deposit. Accordingly, the mineral is much easier to absorb. This is, e.g., advantageous when the apparatus is used in a water supply, since fouling of the installation, e.g. in terms of algae growth, mineral deposits, etc., is reduced. This will in particular be advantageous when the installation comprises a heat exchanger, since minerals, such as calcite, are inclined to deposit in heat exchangers.

Furthermore, it turns out that growth of bacteria and algae in the liquid is impeded when the apparatus of the invention is used, and that the taste of the liquid, e.g. drinking water or wine, is improved.

Finally, the availability of oxygen present in the liquid is improved.

The apparatus may comprise at least three pipe segments being twisted about the common axis. In case the apparatus comprises exactly three pipe segments, the apparatus resembles a robe with three strands. This is a preferred design because three strands may be packed in a relatively compact manner, i.e. with minimum space between the strands. This is particularly the case if the pipe segments have circular cross sections.

Each of the pipe segments may have an at least substantially circular cross section. In this case the pipe segments may be ordinary pieces of cylindrical pipes which are readily available. Alternatively, the cross sections of the pipe segments may have any other suitable shape, such as oval, triangular, square, rectangular, pentagonal, hexagonal, etc. The cross sections of the pipe segments may be identical, or they may vary in terms of shape and/or size.

In case the pipe segments have an at least substantially circular cross section, the sum of the diameters of all the pipe segments may be between 1/20 and 1/10 of the length of the apparatus along a longitudinal direction defined by the common axis. Thus, if the length of the apparatus along the longitudinal axis is 100 mm, the sum of the diameters of the pipe segments should, according to this embodiment, be between 5 mm and 10 mm. It is, however, important that the ratio between the sum of the diameters of the pipe segments and the length of the apparatus is selected in such a manner that the liquid obtains a sufficient spin when passing through the pipe segments to obtain the effects described above. This is, e.g., obtained when the ratio above is used while the pipe segments are rotated one turn about the common axis.

The pipe segments may be made from a corrosion resistant material, e.g. a plastic material, preferably a food compatible plastic material, such as polyethylene or polypropylene. Alternatively or additionally, the pipe segments may be made from or comprise a ceramic material. In this case the pipe segments may, e.g., be formed in a core made from the ceramic material.

Alternatively or additionally, the pipe segments may be made from a metal, such as copper, stainless steel, and/or any other suitable metal.

The apparatus may further comprise a common pipe arranged coaxially with the common axis in such a manner that the pipe segments are at least substantially encapsulated by the common pipe. According to this embodiment the apparatus is encapsulated by the common pipe. Thereby the appearance of the apparatus is similar to a normal pipe, and it will be possible to easily arrange connections, such as threaded portions and/or sleeves at the common inlet and the common outlet for easy connection of the apparatus into existing water supplies.

In an apparatus according to this embodiment, the sum of the cross sectional areas of the pipe segments preferably constitutes a substantial part of the cross sectional area of the common pipe. Thus, the sum of the cross sectional areas of the pipe segments is preferably at least 50% of the cross sectional area of the common pipe, such as at least 75%, such as at least 80%, such as at least 90%, such as at least 95%, such as at least 98%.

The invention further relates to a decantation device having an apparatus according to the invention arranged in a flow path thereof. Such a decantation device may be a device for decantation of wine, and it may advantageously be shaped and sized in such a manner that it can be received in the neck of an ordinary wine bottle. The apparatus according to the invention may then be positioned in such a manner that when wine is poured from the bottle, via the decantation device, it passes through the apparatus. Thereby the wine is spun as described above while being poured.

Furthermore, the invention relates to a water supply system having an apparatus according to the invention arranged in a flow path thereof. Such a water supply system may advantageously be a system for supplying drinking water to humans or animals. This has already been described above.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will now become more fully understood from the detailed description given hereinbelow and the accompanying drawings, which are given by way of illustration only, and thus are not limitative of the present invention, and in which:

FIGS.. 1a-1c illustrate an apparatus according to a first embodiment of the invention and having two pipe segments,

FIGS. 2a-2c illustrate an apparatus according to a second embodiment of the invention and having three pipe segment,

FIGS. 3a-3c illustrate an apparatus according to a third embodiment of the invention and having four pipe segments, and

FIGS. 4a-4e illustrate a decantation device having an apparatus according to the invention arranged in a flow path thereof.

### DETAILED DESCRIPTION OF THE PREFERRED EMBODIMENTS

FIG. 1a is a perspective view of an apparatus 1 according to a first embodiment of the invention. The apparatus 1 comprises two pipe segments 2, each being twisted about a common axis. Each of the pipe segments 2 has a substantially circular cross section, and is provided with an inlet opening (not visible) and an outlet opening 3. Around the inlet openings there is arranged a first sleeve 4 which keeps the inlet openings together and defines a common inlet opening. Similarly, a second sleeve 5 is arranged around the outlet openings 3 for keeping the outlet openings 3 together and defining a common outlet opening.

The first sleeve 4 is connectable to a liquid supply. Thereby liquid may be transferred into each of the pipe segments 2 via the common inlet opening defined by the first sleeve 4. The liquid is then transferred parallelly via the two pipe segments 2 to the outlet openings 3 where it leaves the apparatus 1 via the common outlet opening defined by the second sleeve 5.

As the liquid is transferred in the pipe segments 2 it performs a spiralling movement. Thereby the advantages described above are obtained, i.e. the minerals present in the liquid become more readily absorbable for living organisms, and the taste of the liquid is improved.

FIG. 1b is a side view of the apparatus 1 of FIG. 1a. The pipe segments 2, the first sleeve 4 and the second sleeve 5 are visible.

FIG. 1c is an end view of the apparatus 1 of FIGS. 1a and 1b, seen from the end where the outlet openings 3 are arranged. The second sleeve 5 and the outlet openings 3 are, thus, visible.

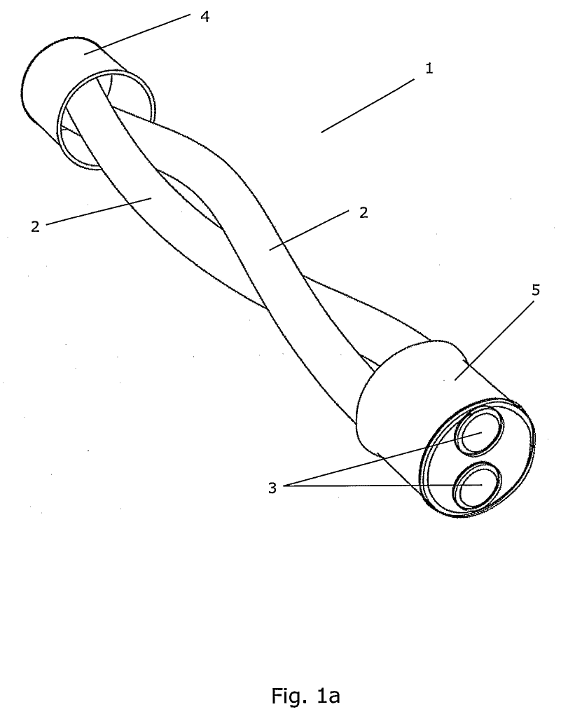

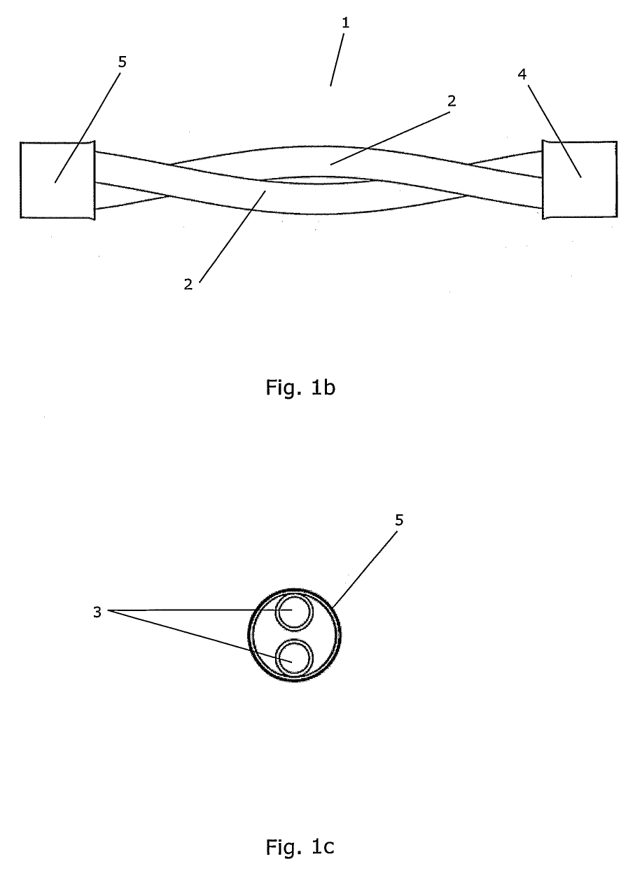

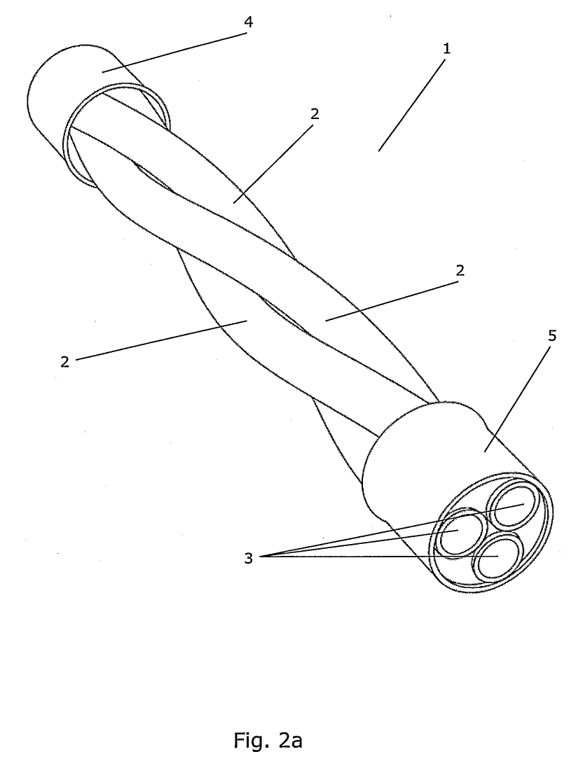

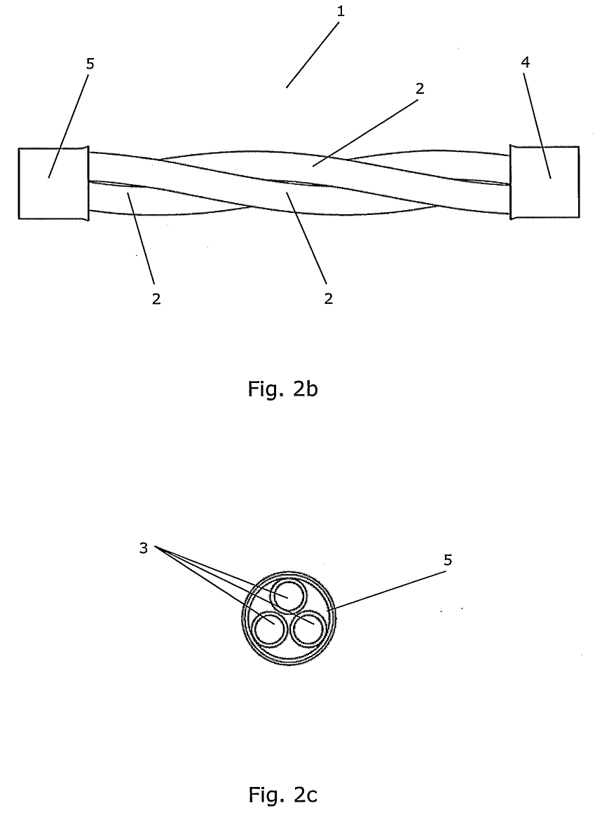

FIG. 2a is a perspective view of an apparatus 1 according to a second embodiment of the invention. The apparatus 1 of FIG. 2a comprises three pipe segments 2 twisted about a common axis. Each of the pipe segments 2 has a substantially circular cross section, and is provided with an inlet opening (not visible) and an outlet opening 3. A first sleeve 4 is arranged around the inlet openings, and a second sleeve 5 is arranged around the outlet openings 3. This is similarly to the situation described with reference to FIG. 1a, and the remarks set forth in that connection are equally applicable here. However, as mentioned above, the apparatus of FIG. 2a comprises three pipe segments 2. This is an advantageous embodiment because it is easy to ‘pack’ three pipe segments 2, each having a circular cross section, in a very ‘tight’ manner, i.e. with very little air between the pipe segments 2.

FIG. 2b is a side view of the apparatus 1 of FIG. 2a, and FIG. 2c is an end view of the apparatus 1 of FIGS. 2a and 2b, seen from the end where the outlet openings 3 are arranged.

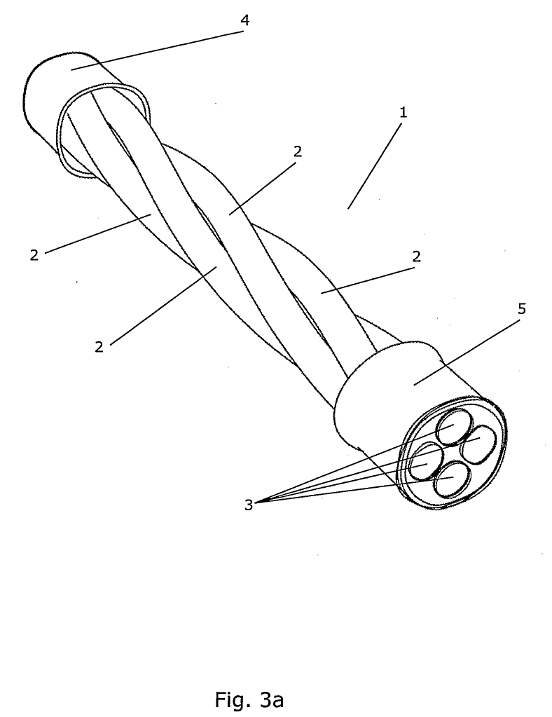

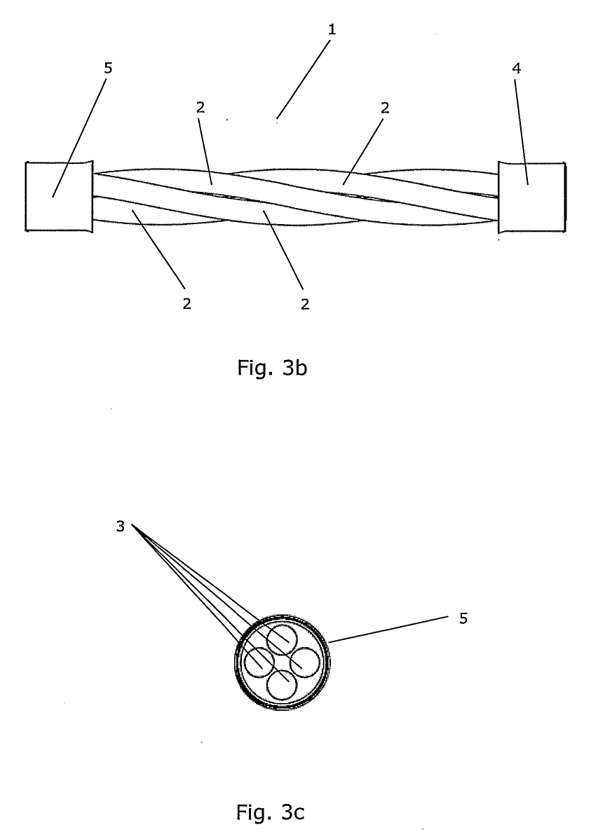

FIG. 3a is a perspective view of an apparatus 1 according to a third embodiment of the invention. The apparatus 1 of FIG. 3a comprises four pipe segments 2 twisted about a common axis. Each of the pipe segments 2 has a substantially circular cross section, and is provided with an inlet opening (not visible) and an outlet opening 3. The apparatus 1 is provided with a first sleeve 4 and a second sleeve 5 as described above with reference to FIGS. 1a and 2a. The remarks set forth above regarding the operation of the apparatus 1 are equally applicable here.

FIG. 3b is a side view of the apparatus 1 of FIG. 3a, and FIG. 3c is an end view of the apparatus 1 of FIGS. 3a and 3b, seen from the end where the outlet openings 3 are arranged.

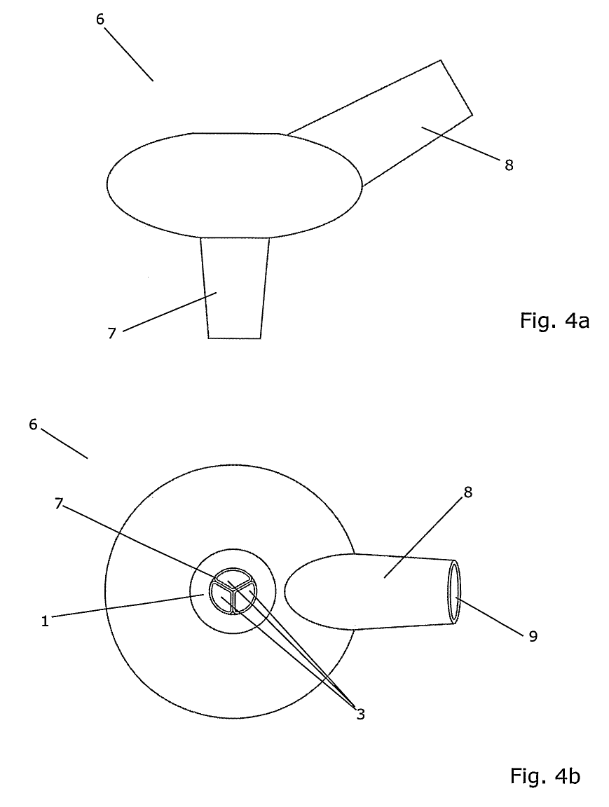

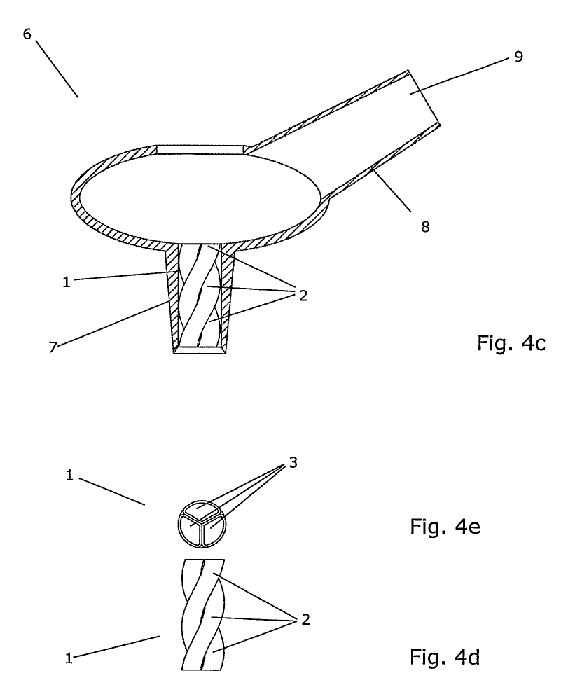

FIG. 4a is a side view of a decantation device 6 according to an aspect of the invention. The decantation device 6 comprises a first portion 7 being adapted to be inserted into a neck portion of an ordinary wine bottle, and a second portion 8 adapted to be used for pouring wine from a wine bottle via the decantation device 6. Inside the first portion 7 an apparatus (not visible) according to the invention is arranged. This will be described further below.

FIG. 4b is a top view of the decantation device 6 of FIG. 4a. In FIG. 4b a pouring opening 9 of the second portion 8 is visible. Wine can be poured from the pouring opening 9.

In FIG. 4b the apparatus 1 can be seen. The apparatus 1 arranged in the first portion 7 comprises three pipe segments, each having a cross section of a substantially triangular shape, and each being twisted about a common axis. The pipe segments each have an inlet opening (not visible) and an outlet opening 3, and the pipe segments are seen from the end where the outlet openings 3 are arranged.

The substantially triangular shape of the cross sections of the pipe segments makes it possible to twist the pipe segments very closely together, and it can be seen that there is almost no space between the pipe segments of the apparatus 1 seen in FIG. 4b.

FIG. 4c is a cross sectional view of the decantation device 6 of FIGS. 4a and 4b. The position of the apparatus 1 inside the first portion 7 is clearly seen. It is also clear that the pipe segments 2 are twisted about a common axis.

The decantation device 6 of FIGS. 4a-4c may be operated in the following manner. The first portion 7 is inserted in a neck portion of a wine bottle containing wine. When the wine is poured, it initially passes through the pipe segments 2 of the apparatus 1 arranged inside the first portion 7. Thereby the wine is spun, and the taste of the wine is accordingly improved as described above. The wine is then poured from the decantation device 6 via the second portion 8 and the pouring opening 9.

FIG. 4d is a side view and FIG. 4e is an end view of the apparatus 1 arranged in the first portion of the decantation device of FIGS. 4a-4c.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An apparatus for treating a liquid, the apparatus comprising:
at least two pipe segments being twisted about a common axis in such a manner that each of the pipe segments at least substantially abuts said common axis, each pipe segment having an inlet opening for receiving a flow of liquid and an outlet opening for delivering a flow of liquid,
wherein the inlet openings are connectable to a common inlet providing a flow of fluid to each of the pipe segments,
wherein the outlet openings are connectable to a common outlet for leading a flow of liquid away from each of the pipe segments, the pipe segments thereby forming parallel flow paths between the common inlet and the common outlet, and
wherein each of the pipe segments is an ordinary piece of rigid cylindrical pipe.

2. The apparatus according to claim 1, the apparatus comprising at least 3 pipe segments being twisted about the common axis.

3. The apparatus according to claim 1, wherein each of the pipe segments has an at least substantially circular cross section.

4. The apparatus according to claim 3, wherein the sum of the diameters of all the pipe segments is between 1/20 and 1/10 of the length of the apparatus along a longitudinal direction defined by the common axis.

5. The apparatus according to claim 1, wherein the pipe segments are made from a corrosion resistant material.

6. The apparatus according to claim 1, wherein the pipe segments are made from a metal.

7. The apparatus according to claim 1, further comprising a common pipe arranged coaxially with the common axis in such a manner that the pipe segments are at least substantially encapsulated by the common pipe.

8. A decantation device having an apparatus for treating a liquid, the apparatus laving at least two pipe segments being twisted about a common axis in such a manner that each of the pipe segments at least substantially abuts said common axis, each pipe segment having an inlet opening for receiving a flow of liquid and an outlet opening for delivering a flow of liquid, wherein the inlet openings are connectable to a common inlet providing a flow of fluid to each of the pipe segments, wherein the outlet openings are connectable to a common outlet for leading a flow of liquid away from each of the pipe segments, the pipe segments thereby forming parallel flow paths between the common inlet and the common outlet, and wherein each of the pipe segments is an ordinary piece of rigid cylindrical pipe, the apparatus being arranged in a flow path thereof.

9. A water supply system having an apparatus for treating a liquid, the apparatus having at least two pipe segments being twisted about a common axis in such a manner that each of the pipe segments at least substantially abuts said common axis, each pipe segment having an inlet opening for receiving a flow of liquid and an outlet opening for delivering a flow of liquid, wherein the inlet openings are connectable to a common inlet providing a flow of fluid to each of the pipe segments, wherein the outlet openings are connectable to a common outlet for leading a flow of liquid away from each of the pipe segments, the pipe segments thereby forming parallel flow paths between the common inlet and the common outlet, and wherein each of the pipe segments is an ordinary piece of rigid cylindrical pipe, the apparatus being arranged in a flow path thereof.

10. A decantation device having an apparatus for treating a liquid arranged in a flow path thereof, the apparatus comprising at least two pipe segments being twisted about a common axis in such a manner that each of the pipe segments at least substantially abuts said common axis, each pipe segment having an inlet opening for receiving a flow of liquid and an outlet opening for delivering a flow of liquid, wherein the inlet openings are connectable to a common inlet providing a flow of fluid to each of the pipe segments, and wherein the outlet openings are connectable to a common outlet for leading a flow of liquid away from each of the pipe segments, the pipe segments thereby forming parallel flow paths between the common inlet and the common outlet.
